(19) United States
(12) Patent Application Publication
(10) Pub. No.: US 2024/0367009 A1
(43) Pub. Date: Nov. 7, 2024

(54) ADDITIVE MANUFACTURED PICKLEBALL

(71) Applicants: Scott Moonen, Aurora, OH (US); Andrew Kurcsak, Twinsburg, OH (US); Michael D. Stovsky, Beachwood, OH (US)

(72) Inventors: Scott Moonen, Aurora, OH (US); Andrew Kurcsak, Twinsburg, OH (US); Michael D. Stovsky, Beachwood, OH (US)

(21) Appl. No.: 18/654,871

(22) Filed: May 3, 2024

Related U.S. Application Data
(60) Provisional application No. 63/500,391, filed on May 5, 2023.

(51) Int. Cl. A63B 37/00; A63B 102/08; B29C 64/124; B29C 64/386; B29D 22/04; B29L 31/54; B33Y 10/00; B33Y 50/00; B33Y 80/00

(52) U.S. Cl. CPC A63B 37/0098; B29C 64/124; B29C 64/386; B29D 22/04; B33Y 10/00; B33Y 50/00; B33Y 80/00; A63B 2102/08; B29L 2031/54

(57) ABSTRACT

A method of forming a pickleball in an additive manufacturing system includes selecting one of a polymer or liquid resin material from which the pickleball is to be additively manufactured. A computer file is provided containing computer readable instructions for the automated additive manufacturing of a computer generated model of the pickleball, the instructions including a definition of the geometric shape of the pickleball divided into a plurality of successively layered cross sectional slices. A 3D printer executes the instructions to initiate an automated additive manufacturing of a physical pickleball from the selected polymer, corresponding to the design of the computer generated model. The 3D printer creates solid cross sections of the pickleball in the selected material that are progressively and integrally bonded together and correspond to the successively layered cross sectional slices of the pickleball design, to form a complete pickleball.

### CROSS-REFERENCE TO RELATED APPLICATIONS

This application claims priority to U.S. Provisional Application Ser. No. 63/500,391 filed May 5, 2023, the entire contents of which is hereby incorporated by reference herein.

### FIELD

The present disclosure generally relates to additive manufacturing, and more specifically relates to additive manufactured pickleballs.

### BACKGROUND

Pickleball is a racket/paddle sport that is similar to tennis and other sports that are played on a court with a ball and racket/paddle. Essentially, pickleball players on either side of a net use paddles with varying designs but without strings to hit a pickleball back and forth over the net. In general, pickleballs are hard plastic “wiffle-type” balls including a number of holes as part of their design. Pickleballs are typically either injection molded in two halves that are then welded together, such as by ultrasonic welding or spin welding, or are rotomolded or rotational molded as a one piece ball.

For injection molding a pickleball, a molding tool must be fabricated. Due to the mechanics of the injection molding process, an injection molded pickleball is molded in two halves that are subsequently welded together. The holes of the pickleball are formed either by integrally molding the holes into each of the ball halves during the injection molding process (i.e. the mold contains features that create the holes), or the ball halves are injection molded as solid hemispherical shells without holes and the holes are subsequently drilled into the ball halves after molding. When the two halves of injection molded balls are welded together, they leave a circular weld seam around a circumference of the ball at the interface where the two halves have been welded to each other. The weld seam on the pickleball, however, can be uneven and may cause issues during play. Moreover, the weld seam can be a weak point causing the ball to prematurely split or crack. Further, the outside wall of an injection molded pickleball is relatively weak and susceptible to cracking during play due to the compression placed on the pickleball, and the resulting deformation/deflection of the pickleball, when struck during play. Additionally, an injection molded pickleball can be out-of-round when new, or can become out-of-round during play, which may cause the pickleball to not fly true during play. Because the mold used to manufacture an injection molded pickleball is fabricated based on the specifications of the particular design of the pickleball being manufactured, any modifications to the pickleball specifications would require retooling of the mold and/or a modification to related molding equipment or fixturing.

Similarly, when manufacturing a pickleball using a rotomolding, or rotational molding process, a mold must be fabricated. As an example of the rotational molding process, a plastic powder is placed inside a mold and the mold is sealed closed. The mold is heated up and slowly rotated about several axes, causing the softened plastic powder to evenly disperse and stick to the walls of the mold to form a hollow part in the shape of the mold—in this case, a pickleball. The balls come out of the rotational mold as a hollow ball without any holes in it. The holes in the rotational molded pickleball are then created by drilling holes through the walls of the hollow ball after it is removed from the mold. Similar to the injection molded pickleball, the outside wall of a rotational molded pickleball is relatively weak and susceptible to cracking during play due to the compression placed on the pickleball, and the resulting deformation/deflection of the pickleball, when struck during play. In addition, the rotational molded pickleball can be out-of-round when new, or can become out-of-round during play, and any modifications to the pickleball specifications would also require retooling of the mold and/or a modification to related fixturing. Additionally, with this manufacturing process, it is difficult to hold a consistent wall thickness, which causes the outside wall to be weak and may lead to the center of mass not being in the center of the ball, resulting in the ball not flying true.

The description provided in the background section should not be assumed to be prior art merely because it is mentioned in or associated with the background section. The background section may include information that describes one or more aspects of the subject technology.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 is a perspective view of an example pickleball according to certain aspects of the disclosure.

FIG. 2 is a perspective section view of an example pickleball with portions cut away to illustrate rib structures on the interior of the pickleball, according to certain aspects of the disclosure.

FIG. 3 is a perspective section view of an example pickleball with portions cut away to illustrate a plurality of rim ribs disposed on the interior of the pickleball and localized about the rims, or inner circumferential perimeter edges, of the holes or apertures defined in the pickleball, according to certain aspects of the disclosure.

FIG. 4 is a perspective view of an example pickleball with an identifying mark section on the exterior of the pickleball, according to certain aspects of the disclosure.

FIG. 5 is a block diagram illustrating an example system for additive manufacturing of pickleballs including a device in communication with a three-dimensional (“3D”) printer, according to certain aspects of the disclosure.

FIG. 6 is a block diagram illustrating an example computer system with which the example device of FIG. 5 can be implemented.

In one or more implementations, not all of the depicted components in each figure may be required, and one or more implementations may include additional components not shown in a drawing figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The present disclosure provides systems and methods for manufacturing a pickleball via additive manufacturing.

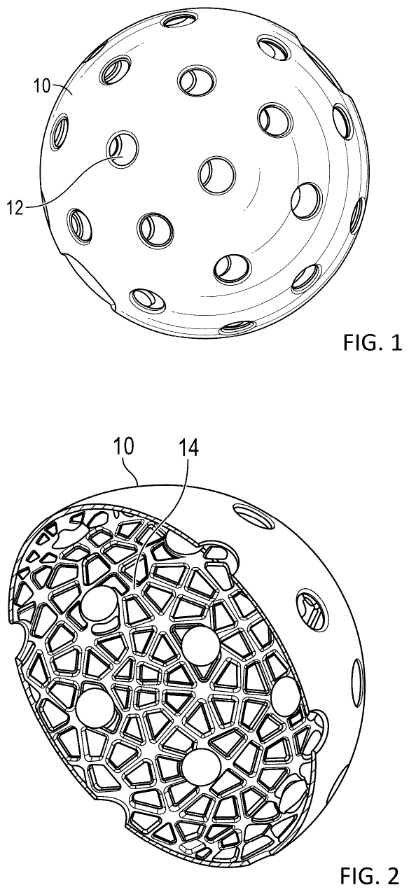

FIG. 1 illustrates an example pickleball 10, which is manufactured via additive manufacturing, for example via 3D printing or the like, in accordance with certain aspects of the present disclosure. “3D printing” and/or additive manufacturing, as used herein, is any process of making physical real-world three dimensional objects, from a computer created digital 3D design of the object stored in a digital computer file. The digital design of the object is sliced into a series of horizontal planes to create a series of horizontally aligned cross sectional slices. A 3D printer builds up the physical object incrementally from the cross sectional slices of the of the object, by successively “printing” each of the thin cross sectional slices of the object a layer at a time, with each layer bonding to the previously printed layer, usually from one or more of a molten, liquid, or powdered material. 3D printing and/or additive manufacturing can include, but is not limited to, one or more of the categories of additive manufacturing processes defined in ISO/ASTM52900-15, including material extrusion, material jetting, binder jetting, powder bed fusion, and stereolithography and other photopolymerization methods/processes such as continuous liquid interface production (“CLIP”), without departing from the scope of the present disclosure. A “3D printer,” as used herein, is any equipment or device capable of producing a physical object by any of the above mentioned processes.

The pickleball 10 of the present disclosure is manufactured in one piece, as a seamless hollow ball (i.e., does not include a welding or molding seam), which is advantageous during play as the pickleball is uniformly round and weighted, having generally uniform wall thickness and a smooth outer surface. A traditional pickleball however, that is injection molded in two hemispherical halves that are subsequently welded together, has a circular circumferential seam disposed at the location on the pickleball where the two halves are welded together. This seam is a weak point in the structural integrity of the injection molded pickleball, along which seam stress in the pickleball may be concentrated during use, and at which seam the pickleball can prematurely split in half or crack. In contrast, a seamless pickleball 10 of the present disclosure reduces or eliminates such localized stress concentration and any resulting premature splitting or cracking. The seamless additive manufactured pickleball 10 of the present disclosure is designed to be spherical in shape as manufactured, and to maintain its spherical shape during play more readily than an injection molded or rotational molded pickleball (e.g., is not out-of-round). This allows the seamless pickleball 10 to fly true during play. The pickleball 10 of the present disclosure is also designed to control and disperse the compression and flex, or deformation/deflection, on the outer wall of the pickleball during play to reduce splitting or cracking of the outer wall when struck during play.

The pickleball 10 includes a plurality of holes or apertures 12 that are integrally created in the wall of the pickleball during the additive manufacturing process. For example, the plurality of holes or apertures 12 are not drilled into the pickleball 10, but are integrally created during the layer-by-layer build (i.e., additive manufacturing) process. The plurality of holes or apertures 12 can include any number of holes or apertures 12 as is called for in the particular pickleball design, without departing from the scope of the present disclosure. In certain aspects, the plurality of apertures 12 can include twenty-six (26) apertures, forty (40) apertures, or any other number of appropriate apertures as desired to achieve various performance characteristics in the pickleball 10.

With reference to FIG. 2, in certain aspects, the pickleball 10 includes one or more internal reinforcement structure(s) or feature(s) that protrude inward from the interior surface of the wall of the pickleball and extend generally toward a hollow center of the pickleball 10. One example of such an internal structure is an internal rib structure 14. The rib structure 14 is integrally formed on an interior surface of the pickleball 10 during the additive manufacturing process. The rib structure 14 is designed both to strengthen the outside wall and/or outer surface of the pickleball 10, while minimizing the amount of weight added to the pickleball 10 to achieve the increased strength. The rib structure 14 is configured to stiffen or strengthen the outside wall or surface of the pickleball 10 to control and disperse deformation/deflection, or the amount of flex of the outside wall, of the pickleball 10, thereby creating a structure that is less susceptible to cracking or splitting during play without adding unnecessary weight to the pickleball 10. While the exemplary rib structure 14 depicted in FIG. 2 is illustrated as a random web of interconnected ribs, or a lattice-type pattern of interconnected ribs, the pattern of the rib structure 14 can be any suitable pattern to stiffen the outside wall, without departing form the scope of the present disclosure. The rib pattern can be either a uniform pattern or a random pattern. A width of the ribs, and a height of the ribs as they extend distal (or away) from the inner surface of the pickleball 10, can be varied as needed to achieve different strength, deformation/deflection, response, and performance characteristics, without departing from the scope of the present disclosure. Indeed, the rib structure of a given pickleball 10 can include ribs that all have a uniform rib height and a uniform rib width throughout the rib structure of the pickleball 10. Alternatively, the rib structure of a given pickleball 10 design can include a combination of individual ribs, or rib sections, that have rib widths or rib heights that vary from rib-to-rib, or rib-section to rib-section, within the same pickleball 10.

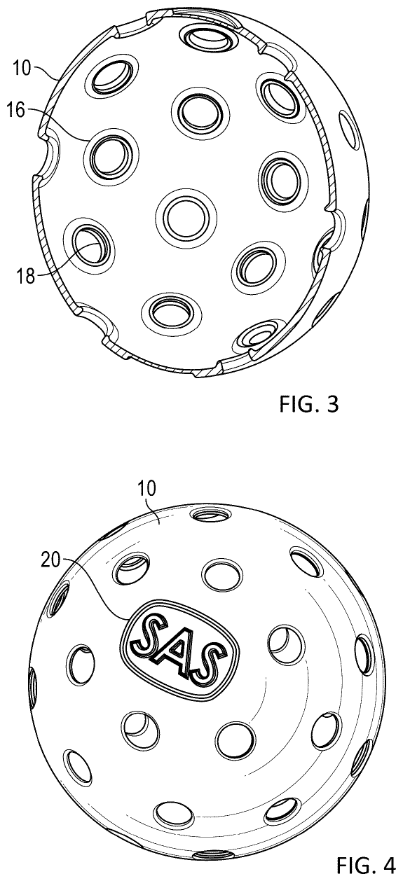

Referring to FIG. 3, in certain aspects, an embodiment of the pickleball 10 includes a plurality of rim ribs 16. The plurality of rim ribs 16 are formed on the interior surface of the pickleball 10 during the additive manufacturing process, with each rim rib of the plurality of rim ribs 16 localized around a corresponding rim 18, or internal circumferential or peripheral edge, of each hole or aperture of the plurality of holes or apertures 12. The plurality of rim ribs 16 provide additional structural reinforcement and increased strength to the interior wall of the pickleball 10 at the location of each hole or aperture while still permitting the thinner outside walls of the pickleball 10 between each such rim rib 16 to deflect or flex when the pickleball is struck during play.

As illustrated in FIG. 4, in certain aspects, the pickleball 10 includes an identifying marks section 20. The identifying marks section 20 is integrally formed on or within the outside wall of the pickleball 10 during the additive manufacturing process. The identifying marks section 20 can be incorporated into, or recessed in the outer surface of the pickleball 10, such that the outer surface of the pickleball 10 is a generally smooth surface/texture, without any features protruding outward past the generally smooth outer surface. The identifying marks section 20 can include one or more identifying mark, including, but not limited to, logos, brands, model identification, performance or design specification information, personalized names of individuals or companies/entities, or any other appropriate identifying words or marks in various shapes, styles, and/or colors without departing form the scope of the present disclosure. Because the identifying marks section 20 is formed during the additive manufacturing process, the information provided in the identifying marks section can be easily customized and applied on-demand, without any need for retooling or changing out parts or cores of a mold or tool, as would otherwise be required to do so with traditional manufacturing processes like injection molding or rotational molding processes.

In the present disclosure, a method of forming a pickleball of the present disclosure by an additive manufacturing system or process includes identifying and selecting a polymer, resin, plastic, or other similar material from which the pickleball is to be made in an additive manufacturing system. A computer file is provided containing a computer generated model, or computerized design, representing the specific one-piece hollow pickleball that is to be additively manufactured. The computer generated model includes all of the internal and external design features of the pickleball to be manufactured. The computer generated model is created using computer aided design (CAD) software installed on a device 510, such as a laptop computer or other such computerized device. The computer file additionally contains computer readable instructions that define all aspects of the geometric shape of the pickleball, including the shape of the pickleball divided by horizontal planes into a plurality of successively layered cross sectional slices. Typically, the layered cross sectional sliced are oriented in a horizontal plane.

The computer readable instructions are executed to initiate an automated 3D printing or additive manufacturing of a physical pickleball from the selected polymer, that corresponds to the design of the computer generated model saved in the computer file.

In one embodiment of the automated 3D printing or additive manufacturing of a pickleball, upon execution of the instructions, a print head of a 3D printer deposits a plurality of successive layers of material, such as a molten polymer, that become bonded together either as they are deposited, or thereafter in a subsequent thermal or light curing process, and which layers correspond to the successively layered cross sectional slices of the pickleball design in the computer readable instructions. In this manner, a complete pickleball is formed, in a layer-by-layer additive manufactured fashion, including the integrated holes and any internal structures protruding inward from the interior surface of the wall of the pickleball toward the hollow center thereof. The layer thickness of each cross sectional slice defined in the computer file corresponds to the layer thickness of each layer deposited or created by the 3D printer. The thinner the cross sectional slices, the thinner the layer of polymer deposited or created by the 3D printer, and the higher the resolution of the fully completed physical pickleball.

In an alternate embodiment of the automated 3D printing or additive manufacturing of a pickleball, a stereolithography 3D printer may be used. Upon execution of the instructions, an ultraviolet laser projects or traces each cross sectional slice of the pickleball one at a time onto a top surface of a pool of a liquid photocurable or photopolymer resin, thereby curing and hardening only the resin at the surface of the pool that contacted the beam of the laser, creating a solid layer of the object. The solidified layer of the pickleball is then lowered below the surface of the liquid resin to allow new liquid resin to flow over the layer that was just cured. The laser then projects or traces the next cross sectional slice of the pickleball design on the liquid resin surface which creates and bonds the next layer to the preceding cured layer of the pickleball. In this manner, a complete pickleball is formed, in a layer-by-layer additive manufactured fashion, including the integrated holes and any internal structures protruding inward from the interior surface of the wall of the pickleball toward the hollow center thereof.

In yet another alternate embodiment of the automated 3D printing or additive manufacturing of a pickleball, a CLIP 3D printer may be used. Upon execution of the instructions, an ultraviolet (UV) light beam is projected upwards through a transparent window in the bottom of a tank that holds a pool of liquid photocurable or photopolymer resin. The light beam in the shape of a precise cross sectional slice of the design of the pickleball is projected upwards onto the liquid resin on the bottom of the pool above the window, thereby curing and solidifying only the resin at the bottom of the pool on which the light beam was projected. The solidified portion of the pickleball is then continuously slowly raised in the tank allowing additional liquid resin to continuously flow under, and maintain contact with, the bottom of the solidified portion of the pickleball that has already been formed. And as the solidified portion of the pickleball is continuously being raised and new liquid resin flows beneath the solidified portion of the pickleball, the particular cross section of the pickleball being projected by the UV light beam onto the bottom of the pool of liquid resin at any given time is also continuously changing, so as to continuously solidify the new liquid resin flowing beneath the upward moving solidified part. In this manner, liquid resin is continuously being cured and the physical pickle ball is continuously being created as it moves upward through the pool of liquid resin. Thus, a complete pickleball is continuously formed from start to finish, including the integrated holes and any internal structures protruding inward from the interior surface of the wall of the pickleball toward the hollow center thereof, in a continuous additive manufactured fashion, as it is raised upward in the pool of liquid resin, rather than in a layer-by-layer fashion accomplished by other 3D printers and 3D printing processes.

Using any of the 3D printers and 3D processes or additive manufacturing technologies, the layer-by-layer deposition/curing of polymer or resin, or continuous curing of liquid resin, is capable of producing a seamless pickleball that includes no external seams, or seam flashing, from which material is protruding past the outer surface of the pickleball, as would otherwise be created by more traditional methods, such as injection molding the pickleball in two separate hemispherical halves and later welding them together leaving material flashing from the weld seam.

Moreover, due to the layer-by-layer deposition/curing of polymer or resin, or continuous curing of liquid resin, and the ultimate incremental progressive build up of the pickleball's design one cross sectional layer at a time, the cross sections capture not only the outer features and surface of the pickle ball, but the inner surface and features thereof as well. Accordingly, this method permits manufacturing of a pickleball that includes not just outer features disposed on or defined in the outer surface of the pickleball, but internal features, or inner structures disposed on the inner surfaces as well, such as internal rib structures or inner surface rim ribs disposed at any location on the inner surface of the pickleball. It would not be possible to produce a seamless pickleball having such internal features and inner structure, without also creating a weld seam using traditional manufacturing methods of injection molding or rotational molding.

In addition, during the depositing of the plurality of successive layers of polymer, the deposited layers have a uniform polymer layer width, such that the bonded layers form the wall of the pickleball to have a uniform wall thickness at locations of the wall at which no internal reinforcement structure is present.

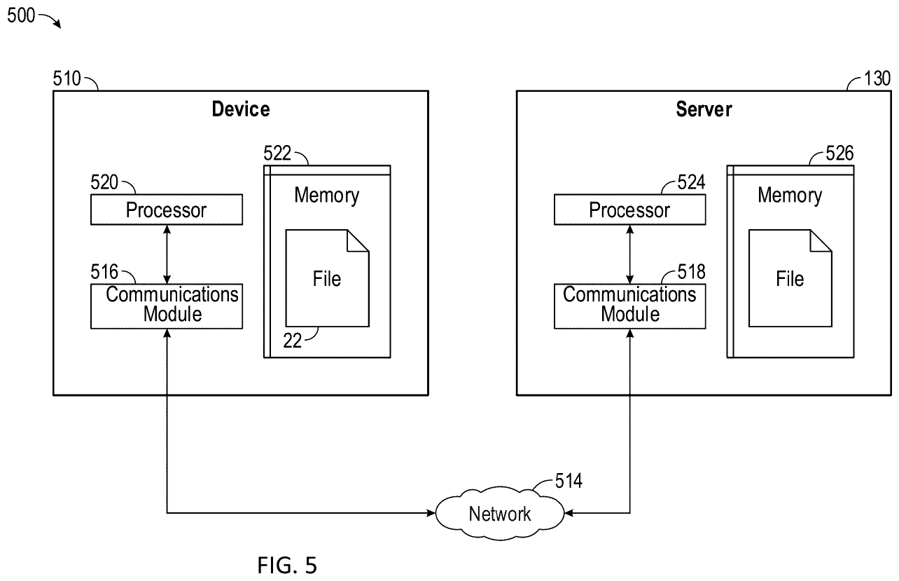

FIG. 5 is a block diagram illustrating an example system 500 for additive manufacturing pickleballs such as the pickleball 10. The system 500 includes a device 510 in communication with a three-dimensional (3D) printer 512. In certain aspects, the device 510 can be hardwired to the 3D printer 512. In other aspects, the device 510 and the 3D printer 512 are connected over a network 514 via respective communication modules 516, 518. The communication modules 516, 518 are configured to interface with the network 514 to send and receive information, such as data, requests, responses, and commands to other devices on the network 514. The communications modules 516, 518 can be, for example, modems or Ethernet cards. The network 514 can include, for example, any one or more of a personal area network (PAN), a local area network (LAN), a campus area network (CAN), a metropolitan area network (MAN), a wide area network (WAN), a broadband network (BBN), the Internet, and the like. Further, the network 514 can include, but is not limited to, any one or more of the following network topologies, including a bus network, a star network, a ring network, a mesh network, a star-bus network, tree or hierarchical network, and the like.

The device 510 can be, for example, a desk top computer, a tablet computer, a mobile phone, a mobile computer, a laptop computer, a portable media player, an electronic book (eBook) reader, or any other device having appropriate processor, memory, and communications capabilities. The device 510 includes a processor 520, the communications module 516, and a memory 522. The processor 520 of the device 510 is configured to execute instructions, such as instructions physically coded into the processor 520, instructions received from software in memory 522, or a combination of both. The device 510 is configured to receive a file 22, which includes instructions for which the processor 520 of the device 10 is configured to execute to initiate additive manufacturing of pickleball 10 by the 3-D Printer 512. The file 22 can be any appropriate file format for additive manufacturing processes such as, but not limited to, additive manufacturing file format (AMF), Stl. 3mf, obj, and other suitable file formats. The file 22 can be modified to customize the design of the pickleball 10 such as, but not limited to, adding structure, removing structure, adding, removing, or fine-tuning weight, thickening the outer wall, thinning the outer wall, adding or removing a lattice structure for strengthening the outer wall, adding a rib structure 14 for strengthening the outer wall, adding the plurality of rim ribs 16 to the rim 18 of each aperture of the plurality of apertures 12, selectively changing the shape and/or size of any ribs or sections of rib structure 14, changing the design of the rib structure 14, adding or removing holes or apertures 12 from the pickleball design, modifying the size, shape, and/or location of the holes or apertures 12 in the pickleball design, and other appropriate customizations.

The 3D printer 512 can be, for example, any appropriate 3D printer. While the 3D printer 512 is configured to receive instruction from the device 510, in certain aspects, the 3D printer 512 can be a standalone printer with computing functionality such that it includes a processor 524, the communications module 518, and a memory 526. The processor 524 of the 3D printer 512 is configured to execute instructions, such as instructions physically coded into the processor 524, instructions received from software in memory 526, or a combination of both. The 3D printer 512 is configured to receive instructions from the device 510 to perform additive manufacturing of the pickleball 10 based on the instructions in the file 22.

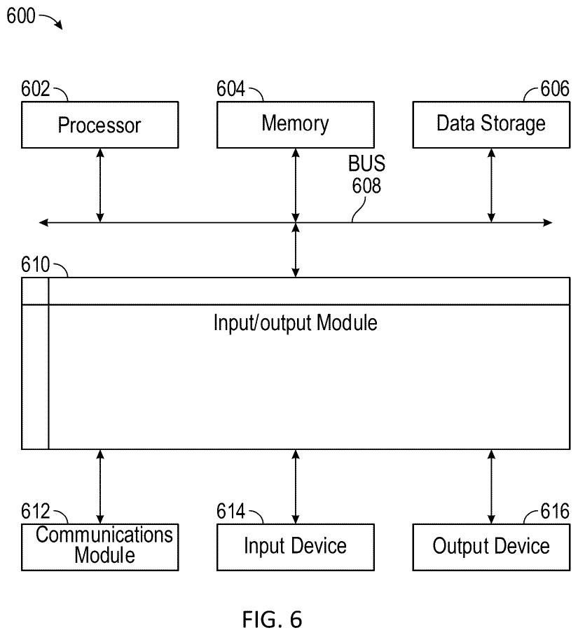

FIG. 6 is a block diagram illustrating an example computer system 600 with which the device 510 and the 3D printer 512 can be implemented. In certain aspects, the computer system 600 may be implemented using hardware or a combination of software and hardware, either in a dedicated server, or integrated into another entity, or distributed across multiple entities.

Computer system 600 (e.g., the device 510 and the 3D printer 512) includes a bus 608 or other communication mechanism for communicating information, and a processor 602 (e.g., the processor 520, 524) coupled with bus 608 for processing information. According to one aspect, the computer system 600 can be a cloud computing server of an IaaS that is able to support PaaS and SaaS services.

Computer system 600 can include, in addition to hardware, code that creates an execution environment for the computer program in question, e.g., code that constitutes processor firmware, a protocol stack, a database management system, an operating system, or a combination of one or more of them stored in an included memory 604 (e.g., the memory 522, 526), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 608 for storing information and instructions to be executed by processor 602. The processor 602 and the memory 604 can be supplemented by, or incorporated in, special purpose logic circuitry.

The instructions may be stored in the memory 604 and implemented in one or more computer program products, e.g., one or more modules of computer program instructions encoded on a computer readable medium for execution by, or to control the operation of, the computer system 600.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 600 further includes a data storage device 606 such as a magnetic disk or optical disk, coupled to bus 608 for storing information and instructions. Computer system 600 may be coupled via input/output module 610 to various devices. The input/output module 610 can be any input/output module. Example input/output modules 610 include data ports such as USB ports. In addition, input/output module 610 may be provided in communication with processor 602, so as to enable near area communication of computer system 600 with other devices. The input/output module 610 may provide, for example, for wired communication in some implementations, or for wireless communication in other implementations, and multiple interfaces may also be used. The input/output module 610 is configured to connect to a communications module 612. Example communications modules 612 (e.g., the communications module 516, 518) include networking interface cards, such as Ethernet cards and modems.

In certain aspects, the input/output module 610 is configured to connect to a plurality of devices, such as an input device 614, and/or an output device 616. Example input devices 614 include a keyboard and a pointing device, e.g., a mouse or a trackball, by which a user can provide input to the computer system 600. Other kinds of input devices 614 can be used to provide for interaction with a user as well, such as a tactile input device, visual input device, audio input device, or brain-computer interface device.

According to one aspect of the present disclosure the device 510 and the 3D printer 512 can be implemented using a computer system 600 in response to processor 602 executing one or more sequences of one or more instructions contained in memory 604. Such instructions may be read into memory 604 from another machine-readable medium, such as data storage device 606. Execution of the sequences of instructions contained in main memory 604 causes processor 602 to perform the process steps described herein. One or more processors in a multi-processing arrangement may also be employed to execute the sequences of instructions contained in memory 604. Processor 602 may process the executable instructions and/or data structures by remotely accessing the computer program product, for example by downloading the executable instructions and/or data structures from a remote server through communications module 612 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

The term “machine-readable storage medium” or “computer-readable medium” as used herein refers to any medium or media that participates in providing instructions or data to processor 602 for execution. The term “storage medium” as used herein refers to any non-transitory media that store data and/or instructions that cause a machine to operate in a specific fashion. Such a medium may take many forms, including, but not limited to, non-volatile media, volatile media, and transmission media.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 608. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A method of forming a pickleball in an additive manufacturing system, comprising:
selecting one of a polymer or liquid resin material from which the pickleball is to be additively manufactured;
providing a computer file containing computer readable instructions for the automated additive manufacturing of a computer generated model of a one-piece hollow pickleball having a plurality of uniformly distributed holes defined in an outer wall thereof and an internal reinforcement structure disposed on and protruding inward from an interior surface of a wall of the pickleball, the instructions including a definition of the geometric shape of the pickleball divided into a plurality of successively layered cross sectional slices;
executing, in a 3D printer, the instructions to initiate an automated additive manufacturing of a physical pickleball from the selected polymer, corresponding to the design of the computer generated model;
creating, by the 3D printer, solid cross sections of the pickleball in the selected material that are progressively and integrally bonded together and correspond to the successively layered cross sectional slices of the pickleball design, to form a complete pickleball, in an additive manufactured fashion, including the integrated holes and internal structure protruding inward from the interior surface of the wall of the pickleball.

2. The method of claim 1, wherein the step of creating solid cross sections of the pickleball that are progressively and integrally bonded together produces a seamless pickleball having no external seams protruding from an outer surface of the wall of the pickleball.

3. The method of claim 1, wherein the internal reinforcement structure is an internal rib structure having a plurality of interconnected ribs that extend inward from the inner surface of the wall of the pickleball toward a center of the pickleball to provide additional strength and rigidity to the outer wall of the hollow pickleball between adjacent holes defined in the pickleball.

4. The method of claim 1, wherein the internal reinforcement structure is a plurality of rim ribs formed around an internal circumferential edge of each hole defined in the wall of the pickleball, and extending inward from the inner surface of the wall of the pickleball toward a center of the pickleball.

5. The method of claim 1, wherein the creating step includes depositing a plurality of successive layers of polymer with a uniform polymer layer width, such that the bonded layers form the wall of the pickleball to have a uniform wall thickness at locations of the wall at which no internal reinforcement structure is present.

6. The method of claim 1, wherein the creating step comprises:
projecting a continuous beam of ultraviolet light in the shape of a cross section of the pickleball on a bottom layer of a pool of photopolymer liquid resin to cure a layer of such resin on which the beam was projected, and
continuously changing the shape of the cross section projected on the liquid resin while simultaneously continuously moving the cured layer of resin upwards within the pool to cure additional layers of new liquid resin introduced beneath the previously cured layer of resin and thereby cause the additional layers of cured resin to bond with the previous layer of cured resin.

7. The method of claim 1, wherein said creating step forms an identifying marks section recessed in an outer surface of the wall of the pickleball.

8. A ball, comprising:
a single-piece seamless hollow spherical shell, defining a plurality of uniformly spaced holes in a wall thereof;
an internal reinforcement structure disposed on an inner surface of the wall of the spherical shell and extending from the inner surface toward a center of the hollow spherical shell, the internal reinforcement structure configured to strengthen the wall of the spherical shell.

9. The ball of claim 8, wherein the internal structure is an internal rib structure of interconnected ribs, that form a web of ribs, protruding inward from the inner surface of the wall of the hollow spherical shell.

10. The ball of claim 8, wherein the internal structure is a plurality of rim ribs formed around an internal circumferential edge of each of the plurality of holes and extending inward from the inner surface of the wall of the of the spherical shell toward a center of the shell.

11. The ball of claim 8, wherein the seamless hollow spherical shell has a substantially smooth outer surface without any weld seams.
